(19) United States
(12) Patent Application Publication
(10) Pub. No.: US 2008/0099732 A1
(43) Pub. Date: May 1, 2008

(54) Electroconductive Resin Composition, Production Method and Use Thereof

(75) Inventors: Yuji Nagao, Kanagawa (JP); Ryuji Yamamoto, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K., Tokyo (JP)

(21) Appl. No.: 11/662,645

(22) PCT Filed: Sep. 13, 2005
(86) PCT No.: PCT/JP05/17233

§ 371 Date: Mar. 13, 2007

Related U.S. Application Data
(60) Provisional application No. 60/611,267, filed on Sep. 21, 2004.

(30) Foreign Application Priority Data
Sep. 14, 2004 (JP) 2004-266356

(51) Int. Cl. H01B 1/24

(52) U.S. Cl. 252/511

(57) ABSTRACT

The electroconductive resin composition comprising 1 to 30 mass % of carbon fiber having a hollow structure, an average filament diameter of 50 to 500 nm and an average aspect ratio of 50 to 1000 and 99 to 70 mass % of resin, wherein the volume ratio of carbon fiber agglomerate to one carbon fiber filament constituting the agglomerate in the resin composition (volume of carbon fiber agglomerate/volume of a carbon fiber filament) is 1500 or less according to the invention can be uniformly dispersed in resin without agglomeration and therefore, a good electroconductivity can be achieved by addition of small amount of the composition.

### CROSS-REFERENCE TO THE RELATED APPLICATIONS

This is an application filed pursuant to 35 U.S.C. Section 111(a) with claiming the benefit of U.S. provisional application Ser. No. 60/611,267 filed Sep. 21, 2004 under the provision of 35 U.S.C. 111(b), pursuant to 35 U.S.C. Section 119(e)(1).

### TECHNICAL FIELD

The present invention relates to an electroconductive resin composition which can be uniformly dispersed in matrix of resin such as thermoplastic resin, thermosetting resin or photocurable resin without forming agglomerate of electroconductive filler in the matrix.

More specifically, the present invention relates to an electroconductive resin composition and a production process thereof, wherein by using carbon fiber having few branches which is prepared by adjusting the raw material composition and the raw material concentration during the reactions, agglomerate of the carbon fiber can be easily raveled out without breaking filaments on mixing with resin and a three-dimensional network structure can be formed in the resultant resin composition with a small amount of the carbon fiber.

Further, the present invention relates to an electroconductive resin composition, which is useful as a filler material which can impart electroconductivity without deteriorating mechanical strength or as an electron emission material for FED (field emission display) when used as material for transparent electrode, electromagnetic shielding, antistatic agent, electroconductive coating material, electroconductive adhesive or secondary battery.

### BACKGROUND ART

Carbon fiber is being used in various composite materials for its excellent properties such as high strength, high elasticity and high electroconductivity. With recent developments of electronics technology, carbon fiber is expected to be used as electromagnetic wave shielding material, electroconductive filler used in antistatic agent, filler in antistatic coating for resin or filler for transparent electroconductive resin. Moreover, for its high slidability and abrasion resistance, carbon fiber is expected to be used in electric brushes and adjustable resistors. Furthermore, carbon fiber, which has high electroconductivity, heat conductance and resistance to electromigration, is attracting attention as wiring material in devices such as LSI.

The filament diameter of polyacrylonitrile carbon fiber (PAN), pitch carbon fiber, cellulose carbon fiber and the like, which are prepared by carbonizing conventional organic fiber through heat treatment under an inert atmosphere, is relatively large, from 5 to 10 μm, and the electroconductivity of these fibers is not so good. Therefore, these carbon fibers have been widely used as reinforcing material for resin, ceramic or the like.

The reasons for using carbon fiber derived from organic fiber mainly as mere reinforcing filler material include that the fiber is so inflexible that filaments break when the fiber is kneaded with resin, that addition of 30 mass % or so is required to obtain desired electroconductivity, and in addition that the thickness and rigidity of the filament causes the fiber filaments in a formed product to be orientated in the same direction. As a result, there are problems of distortion of formed products caused by anisotropy in shrinkage and considerable roughness of formed product surface caused by carbon fiber filaments emerging in the surface.

For the above reasons, resin composition containing carbon fiber derived from organic fiber was considered as unsuitable for precise molding where resin which is highly insulative is imparted with electroconductivity in order to dissipate static electricity and dimensional accuracy is required, and for molding for electronic components where good surface smoothness without a scratch due to contact with cases is required.

In 1980's, studies on vapor grown carbon fiber generated through thermal decomposition of gas such as hydrocarbon in the presence of transition metal catalyst started and thus, carbon fiber having a filament diameter of about 0.1 to about 0.2 μm (about 100 to about 200 nm) became available.

Recently, studies on carbon nanotube having a filament diameter smaller than that of vapor grown carbon fiber are being vigorously made. Examples of production method of carbon nanotube include arc discharge method, laser ablation method and chemical vapor deposition method. For example, in arc discharge method, by carrying out arc discharging between electrodes having catalyst metal incorporated therein to thereby generate a high temperature of 3000° C. or higher, carbon and the catalyst are vaporized and in the cooling process, carbon nanotube is generated from the catalyst metal surface.

Generally, most filaments of vapor grown carbon fiber or carbon nanotube as generated are collected as deposit in sheet-like form or in agglomerates where filaments are tangled with each other. The collected deposit as is is hard to disperse in resin or the like (see U.S. Pat. No. 6,608,133) and therefore, (1) the deposit is mixed with resin after pulverization using a ball mill, a beads mill or the like as pretreatment (see JP-A-2003-308734), or (2) recently a method where the deposit is broken by tribological grinding (solid-phase shear) when the deposit is kneaded with resin and thereby dispersed in the resin has been proposed (JP-A-2002-347020).

The feature of the above process (1) is that large agglomerates of the deposit are broken and reduced into smaller pieces to thereby make the deposit easier to disperse in resin. However, the pieces of the agglomerates cannot be further reduced to finer ones by kneading process using a normal extruder and therefore, without addition of a large amount of filler, an electroconductive network cannot be formed. The electroconductive network here is constituted by fine agglomerates.

In the latter process (2), a high shearing force is applied when the resin is kneaded and, filler is pulverized at the same time when the agglomerates are pulverized, to thereby make the electroconductive filler uniform and monodisperse. However, in light of imparting electroconductivity, in a case where an electroconductive filler is added to resin, there is a report that the larger the aspect ratio of the filler particle, the smaller the filler amount required to obtain electroconductivity. In this process where pulverization of agglomerates is conducted at the same time with pulverization of the filler, merits and advantages of the vapor grown carbon fiber or carbon nonotube are reduced by half. As compared with ideal production process (vapor grown carbon fiber or carbon nonotube is uniformly dispersed in resin without breaking of filaments), a larger amount of filler is required to form an electroconductive network.

### DISCLOSURE OF INVENTION

The present invention solves the above conventional problems and provides an electroconductive resin composition prepared by dispersing every carbon fiber filament as uniform as possible in resin with a smaller amount of electroconductive filler than in conventional method, so that the resin composition can obtain electroconductivity as high as or higher than that of conventional resin compositions, to thereby effectively form an electroconductive network, and production method thereof.

In order for the resin composition to obtain electroconductivity as high as or higher than that of conventional resin compositions with a smaller amount of electroconductive filler, it is important to prevent carbon fiber filaments from three-dimensionally tangling with each other by controlling the composition and concentration of raw materials of the filler and further controlling the concentration of vapor grown carbon fiber in the production process. On the other hand, the present inventors have found out that in mixing with the resin, it is important to (1) suppress the shearing force in the process of mixing the resin with the electroconductive filler to thereby reduce breaking of filaments as much as possible and to (2)prevent the electroconductive filler from excessive diffusing in the matrix resin in kneading process to thereby form and maintain a network structure necessary for exhibiting electroconductivity.

The present inventors have studied on properties of filler and kneading method and found out that, by not allowing the filler to remain in agglomerate in the electroconductive resin composition, the resin composition, which effectively forms an electroconductive network, can be imparted with high electroconductivity with addition of a small amount of filler. Further, the inventors have confirmed that reduction in the blending amount of the carbon fiber and uniform dispersion of the carbon fiber lead to prevention of reduction in mechanical strength inherent in the resin.

According to the present invention, the following electroconductive resin composition and production thereof are provided.

[1] An electroconductive resin composition comprising 1 to 30 mass % of carbon fiber having a hollow structure, an average filament diameter of 50 to 500 nm and an average aspect ratio of 50 to 1000 and 99 to 70 mass % of resin, wherein the volume ratio of carbon fiber agglomerate to one carbon fiber filament constituting the agglomerate in the resin composition(volume of carbon fiber agglomerate/volume of a carbon fiber filament) is 1500 or less.

[2] The electroconductive resin composition according to [1], wherein the BET specific surface area of the carbon fiber is from 3 to 50 m²/g, the average interplaner spacing d₀₀₀₂ is 0.345 nm or less and in the Raman scattering spectrum, the peak height ratio (Id/Ig) of a band ranging from 1341 to 1349 cm⁻¹ (Id) to a band ranging from 1570 to 1578 cm¹ (Id) is from 0.1 to 1.4.

[3] The electroconductive resin composition according to [1], wherein each filament of the carbon fiber has 5 or less portions branching from the filament surface.

[4] The electroconductive resin composition according to [1], wherein the resin is a thermoplastic resin, a thermosetting resin or a photocurable resin.

[5] The electroconductive resin composition according to [1], wherein the average diameter of carbon fiber agglomerates in the resin composition is 0.2 to 10 μm.

[6] The electroconductive resin composition according to [1], wherein the area ratio of carbon fiber agglomerate in an arbitrary cross-section of the resin composition is 5% or less.

[7] The electroconductive resin composition according to [1], wherein the volume resistivity value is 10¹⁰ Ωcm or less.

[8] The electroconductive resin composition according to [7] above, wherein the ratio of Izod Notch impact resistance values of the resin composition to resin raw material (the electroconductive resin composition/resin raw material) is 0.9 or more.

[9] A method for producing an electroconductive resin composition, wherein 1 to 30 mass % of carbon fiber having a hollow structure, an average filament diameter of 50 to 500 nm and an average aspect ratio of 50 to 1000 is mixed with 99 to 70 mass % of molten thermoplastic resin and the mixing energy is 1000 MJ/m³ or less.

[10] A method for producing an electroconductive resin composition, wherein 1 to 30 mass % of carbon fiber having a hollow structure, an average filament diameter of 50 to 500 nm and an average aspect ratio of 50 to 1000 is mixed with 99 to 70 mass % of liquid thermosetting resin and the mixing energy is 1000 MJ/m³ or less.

[11] A method for producing an electroconductive resin composition, wherein 1 to 30 mass % of carbon fiber having a hollow structure, an average filament diameter of 50 to 500 nm and an average aspect ratio of 50 to 1000 is mixed with 99 to 70 mass % of liquid photocurable resin precursor, and the mixing energy is 1000 MJ/m³ or less.

[12] A method for producing an electroconductive resin composition, wherein 99 to 70 mass % of thermoplastic resin pellets are supplied from a hopper of a kneader and 1 to 30 mass % of carbon fiber having a hollow structure, an average filament diameter of 50 to 500 nm and an average aspect ratio of 50 to 1000 is side-fed.

[13] A method for producing an electroconductive resin composition, wherein 99 to 70 mass % of thermoplastic resin powder is supplied mixed with 1 to 30 mass % of carbon fiber having a hollow structure, an average filament diameter of 50 to 500 nm and an average aspect ratio of 50 to 1000 and then the mixture is subjected to molten kneading.

[14] A method for producing an electroconductive resin composition, wherein 99 to 70 mass % of thermosetting resin is mixed with 1 to 30 mass % of carbon fiber having a hollow structure, an average filament diameter of 50 to 500 nm and an average aspect ratio of 50 to 1000 and then the mixture is subjected to curing with heat.

[15] An antistatic material using the electroconductive resin composition described in any one of [1] to [8].

[16] An electroconductive coating material using the electroconductive resin composition described in any one of [1] to [8].

[17] An electroconductive adhesive using the electroconductive resin composition described in any one of [1] to [8].

According to the present invention, since electroconductivity can be expressed by addition of a small amount of carbon fiber, fluidity of the resin can be maintained without deteriorating mechanical properties of the matrix resin. Thus, an electroconductive resin composition having good surface smoothness, dimension accuracy and gloss is provided.

### BRIEF DESCRIPTION OF THE DRAWINGS

FIG. 1 shows an optical micrograph (×1000) of a cross sectional view of the plate prepared in Example 1.

FIG. 2 shows the analysis result of the agglomerate diameter in the micrograph shown in FIG. 1.

### BEST MODE FOR CARRYING OUT THE INVENTION

Hereinafter, the invention is described in more detail. The carbon fiber having a hollow structure as used in the present invention can be prepared by decomposing an organic compound with heat by using a transition metal compound.

As an organic compound serving as raw material for carbon fiber, aromatic hydrocarbon such as toluene, benzene or naphthalene, gas such as ethylene, acetylene, ethane, natural gas or carbon monoxide or a mixture of these gases may be used. Among these, aromatic hydrocarbon such as toluene or benzene is preferable.

The organic transition metal compound is a compound containing a transition metal to serve as catalyst. Examples of transition metal include metals belonging to Groups 4 to 10 of the Periodic Table. Among these, a compound containing ferrocene or nickelocene is preferable.

As catalyst aid which efficiently removes gas such as hydrogen adsorbed onto the transition metal catalyst particle surface in the synthesis/reaction atmosphere to thereby enhance the catalytic activity, a sulfur compound such as sulfur or thiophene may be used.

By using a reducing gas such as hydrogen as carrier gas, the above organic compound, the organic transition metal compound and the sulfur compound which is an optional component are supplied into a reactor heated to 800 to 1300° C. and reacted with each other, to thereby generate carbon fiber.

With respect to the form of raw materials, for example, the organic transition metal compound and the sulfur compound dissolved in aromatic hydrocarbon as raw material may be used, or the materials gasified at a temperature of 500° C. or less may be used. However, in a case where the raw material is in liquid form, vaporization and decomposition of the raw material occur on the inner wall of the reaction furnace (reaction tube), causing an uneven concentration distribution in which the raw material concentration is high locally in some portions, and thus generated carbon fiber tends to aggregate. Therefore, as the form of raw materials, the raw material gasified in advance is preferred for the purposed of making the concentration of the material uniform inside the reaction tube.

The ratio of the transition metal catalyst to sulfur compound catalyst aid (transition metal/transition metal+sulfur compound (ratio on terms of atom)) is preferably 15 to 35 mass %. If the ratio is less than 15 mass %, the catalyst activity becomes too high, increasing the number of branching in the carbon fiber or producing radial carbon fiber, which leads to unpreferable formation of strong aggregates. If the ratio exceeds 35 mass %, since gas such as hydrogen adsorbed onto the catalyst cannot be sufficiently removed, which disturbs carbon source supply to the catalyst and leads to granulation of reaction product, it is not preferred.

The branching number of carbon fiber and the raveling level of filament aggregates depend on raw material concentration at the time of reaction. That is, when the material concentration in vapor phase is high, catalyst particles are formed by heterogeneous nucleation on the surface of the generated carbon fiber, and additional carbon fiber is generated from the carbon fiber surface, to thereby form carbon fiber like a silver frost. Moreover, carbon fiber filaments obtained from materials having a high concentration readily tangle with each other and cannot be easily raveled out. Accordingly, it is preferable that the ratio of the supply amount (g) of raw material to the amount (1) of carrier gas in the reaction tube be 1 g/l or less, more preferably 0.5 g/l, even more preferably 0.2 g/l.

In order to improve adhesion with resin, it is preferable to remove organic substance such as tar attached to the surface of the carbon fiber by heat-treatment in inert atmosphere at 900 to 1300° C. Moreover, in order to increase electroconductivity of the carbon fiber, it is preferable to conduct a heat treatment in inert atmosphere at 2000 to 3500° C. to thereby develop crystals.

The furnace used for heat treatment to develop crystals may be any furnace as far as the furnace can hold the target temperature of 2000° C. or higher, more preferably 2300° C. or higher. For example, Acheson furnace, resistance furnace or high-frequency furnace may be used. Alternatively, the heat treatment may be conducted by directly applying an electrical current to the powder material or formed product in some cases.

The atmosphere of the heat treatment is non-oxidation, preferably inert atmosphere constituted by one or more of argon, helium and neon. With respect to the heat treatment time, in light of productivity, the shorter, the more preferable, and generally 1 hour is sufficient.

In order to further develop crystallization of carbon fiber and thereby increase electroconductivity, boron compound such as boron carbide (B₄C), boron oxide (B₂0₃), elemental boron, boric acid (H₃BO₃) or borate salt may be mixed into carbon fiber in conducting heat treatment at 2000 to 3500° C. in inert atmosphere.

The amount of the boron compound to be added depends on the chemical property and physical property of the compound and is not particularly limited. For instance, in a case where boron carbide (B₄C) is used, the amount is preferably 0.05 to 10 mass %, more preferably 0.1 to 5 mass % based on the carbon fiber.

Through the heat treatment with addition of boron compound, carbon crystallinity of carbon fiber is enhanced and electroconductivity is increased. The boron amount contained in the crystals of carbon fiber or in the surface of the crystals is preferably 0.01 to 5 mass %. For the purpose of improving electroconductivity of the carbon fiber and its affinity with resin, it is more preferable that the boron content be 0.1 mass % or more. Further, since the upper limit of the boron amount which can substitute carbon in the graphenesheet is about 3 mass %, a larger amount of boron, especially 5 mass % or more of boron, which will remain as boron carbides or boron oxides to cause decrease in electroconductivity, is unpreferable.

For the purpose of increasing affinity between the carbon fiber and resin, carbon fiber may be subjected to oxidation treatment to thereby introduce phenolic hydroxyl group, carboxyl group, quinone group or lactone group to the surface of the carbon fiber.

Further, the carbon fiber may be subjected to surface treatment with a silane coupling agent, titanate coupling agent, aluminium coupling agent or phosphoric ester coupling agent or the like.

The vapor grown carbon fiber may be branched as far as the carbon fiber does not form robust aggregates. The number of branching of one filament is preferably 5 or less, more preferably 3 or less.

The filament outer diameter of the vapor grown carbon fiber used in the present invention is from 50 to 500 nm, preferably 90 to 250 nm, more preferably 100 to 200 nm. If the filament outer diameter is less than 50 nm, the surface energy exponentially increases to thereby drastically increase the aggregating power of the filaments. In case of simply kneading agglomeration vapor grown carbon fiber with resin, sufficient dispersion cannot be obtained. Due to agglomerates scattered in the resin matrix, an electroconductive network cannot be formed. If a large shearing force is applied in kneading process for the purpose of obtaining sufficient dispersion, the agglomerates can be broken to diffuse in the matrix. However, when agglomerates are broken, breaking of filaments also proceeds, to thereby fail to obtain electroconductivity as desired.

The aspect ratio of the vapor grown carbon fiber is from 50 to 1000, preferably 55 to 800, more preferably 60 to 500. If the aspect ratio is larger, in other words, if the filament length is longer, the filaments get entangled with each other and cannot easily be raveled out, and thus sufficient dispersion cannot be obtained. On the other hand, if the aspect ratio is less than 50, the blending amount needs to be increased in order to form a linked skeleton structure for achieving electroconductivity, which causes deterioration in fluidity and tensile strength of resin composition and is not preferred.

The BET specific surface area of the vapor grown carbon fiber is preferably from 3 to 50 m²/g, more preferably 8 to 30 m²/g, even more preferably 11 to 25 m²/g. The larger the BET specific surface area, the larger the surface energy, which not only renders the dispersing difficult but also causes insufficient coating of the carbon fiber with resin. As a result, when a composite material is to be prepared, a large BET specific surface area, which causes deterioration of electroconductivity and mechanical strength, is not preferred.

The interplaner spacing d₀₀₂ in X-ray diffraction method is preferably 0.345 nm or less, more preferably 0.343 nm or less, even more preferably 0.340 nm or less.

In the Raman scattering spectrum, the peak height ratio (Id/Ig) of a band ranging from 1341 to 1349 cm⁻¹ (Id) to a band ranging from 1570 to 1578 cm⁻¹ (Id) is preferably from 0.1 to 1.4, more preferably 0.15 to 1.3, even more preferably 0.2 to 1.2.

In order to obtain electroconductivity, the higher the crstallinity of the vapor grown carbon fiber in the in-plane direction and laminate direction, the more preferable. However, when the filament outer diameter is too small, the interplaner spacing is sometimes not small due to influence of curvature. That is, in order to form a linked skeleton structure required for imparting resin with electroconductivity, the balance between dispersibility and crystallinity of the vapor grown carbon fiber is important, and therefore the ranges of the filament outer diameter, the aspect ratio, the BET specific surface area, the interplaner spacing d₀₀₂ in X-ray diffraction method and the peak height ratio (Id/Ig) in the Raman scattering spectrum are to be limited.

Although the resin used in the present invention is not particularly limited, the resin is to be selected from thermosetting resin, photocurable resin or thermoplastic resin. One kind thereof may be used singly or two or more of them may be used in combination.

Examples of thermosetting resin include urea resin, melamine resin, xylene resin, phenol resin, unsaturated polyester, epoxy resin, furan resin, polybutadiene, polyurethane, melamine phenol resin, silicone resin, polyamideimide and silicone resin.

Examples of thermoplastic resin include polyethylene, ethylene-vinyl acetate copolymer resin, polypropylene, polystyrene, AS resin, ABS resin, methacrylic resin, polyvinyl chloride, polyamide, polycarbonate, polyethylene terephthalate, polybutylene terephthalate, cellulose acetate, diallyl phthalate, polyvinyl butyral, polyvinyl alcohol, vinyl acetate resin, ionomer, chlorinated polyether, ethylene-α-olefin copoplymer, ethylene-vinyl acetate copolymer, chlorinated polyethylene, vinyl chloride-vinyl acetate copolymer, vinylidene chloride, acrylic-vinyl chloride copolymer resin, AAS resin, ACS resin, polyacetal, polymethylene pentene, polyphenylene oxide, modified PPO, polyphenylene sulfide, butadiene-styrene resin, thermoplastic polyurethane, polyaminobismaleimide, polysulfone, polybutylene, silicone resin, MBS resin, methacrylate-styrene copolymer resin, polyamideimide, polyimide, polyetherimide, polyarylate, polyallyl sulfone, polybutadiene, polycarbonate-methacrylate composite resin, polyether sulfone, polyether ether ketone, polyphthalamide, polymethyl pentene, tetrafluoroethylene resin, tetrafluoroethylene/hexafluoropropylene copolymer, tetrafluoroethylene/perfluoroalkylvynilether copolymer, tetrafluoroethylene/ethylene copolymer, polyvinylidene fluoride, polychlorotrifluoroethylene, chlorotrifluoroethylene/ethylene copolymer, polyvinyl fluoride and liquid crystal polymer.

As method for preparing the electroconductive resin composition of the present invention, for example, when thermoplastic resin is used as resin, a method where a conventional extruder or kneader is used to knead each component may be employed. In order to prevent breaking of fiber filaments, it is desirable to supply carbon fiber to resin which is in molten state. In this occasion, the lower the screw rotation speed and the compound viscosity (low shearing speed and high temperature), the higher the obtained electroconductivity. In a case where resin pellet is used, it is more desirable to supply the carbon fiber by side-feed than by using a hopper. In a case where resin powder is used, the resin may be mixed with the carbon fiber in advance by using a Henschel mixer or the like and fed by a hopper.

In case of using either of thermosetting resin and a photocurable resin, which are usually viscous liquid (monomer or partially polymerized) at room temperature although can be only sometimes solid (and liquefied upon use by reactive diluent, solvent or the like or by heating), the kneading is easy and therefore the kneading energy required is much small as compared with the case of using thermoplastic resin, and therefore the resin materials are preferred. However, under a curing condition (where heat energy for curing temperature or higher is applied to thermosetting resin or light energy is applied to photocurable resin), the resin can be polymerized and cross-linked to be cured into a formed product, a film (coating), an adhesive or the like.

In kneading, for example, in case of using thermosetting resin, by treating the resin at a temperature of room temperature to curing temperature by using the same apparatus as in the case of thermoplastic resin at a low screw rotation speed and a low compound viscosity (curing temperature or lower), high electroconductivity can be obtained easily.

The carbon fiber used in the present invention as it is exhibits an extremely high dispersibility and therefore, mixing elements needs not be strong. The screw rotation speed depends on the compound productivity, however, within a possible range, the lower the screw rotation speed, the more the breaking and excessive dispersing of the carbon fiber can be reduced, in order to thereby express of high electroconductivity.

It is preferable that the kneading temperature be high within a range where deterioration of the resin does not occur. By high temperature, the shearing force as well as the viscosity of the resin can be reduced and breaking of filaments and excessive dispersing of the carbon fiber can be controlled. The kneading energy depends on the type, molecular weight of the resin and the blending ratio of the resin to the carbon fiber. However, the smaller the energy, the more preferable. It is preferable that the energy be 1000 MJ/M³ or less, more preferably 900 MJ/M³ or less.

Examples of molding method include press molding, extrusion molding, vacuum molding, blow molding and injection molding.

The agglomeration degree of carbon fiber in resin may be defined according to the volume ratio of carbon fiber agglomerate to one carbon fiber filament constituting the agglomerate. In the electroconductive resin composition of the invention, the volume ratio (volume of carbon fiber agglomerate/volume of a carbon fiber filament) is 1500 or less, preferably 1000 or less, more preferably 500 or less, even more preferably 100 or less.

In case of particles, generally the smaller the diameter of the primary particle, the smaller the diameter of the agglomerate. However, if the diameter of the primary particle size is less than submicron, the aggregating power and the attaching force increase and the diameter of the agglomerate cannot be less than a certain value. When this is expressed by relationship between the agglomerate volume and the primary particle volume, the ratio of the agglomerate volume/the primary particle volume is constant with the primary particle diameter of a certain value (submicron) or more. On the other hand, with the primary particle diameter less than a certain value (submicron), since the primary particle diameter gets small with the agglomerate volume being unchanged, the ratio of the agglomerate volume/the primary particle volume increases. That is, with the primary particle diameter less than a certain value (submicron), the agglomeration degree increases.

The same is true in carbon fiber. For instance, when two kinds of carbon fibers having the same aspect ratio and having different filament diameters are compared with each other, with the same agglomeration degree, the two are the same in the volume ratio of the agglomerate volume to one carbon fiber filament constituting the agglomerate. Moreover, with the filament diameter less than a certain value, the volume ratio, i.e., the agglomeration degree increases.

With the agglomeration degree increasing, since the carbon fiber cannot be uniformly dispersed and electroconductive network cannot be formed efficiently, and since portions not coated with resin such as inner portions of agglomerates increase, mechanical properties of the composite decreases.

If the volume ratio of the agglomerate volume to one carbon fiber filament constituting the agglomerate exceeds 1500, mechanical properties of the composite markedly decreases, which is not preferred.

The average size of carbon fiber agglomerate in the resin composition is from 0.2 to 10 μm, preferably 0.4 to 8 μm, more preferably 0.8 to 5 μm.

Since the amount of surface functional group in (graphitized) carbon fiber having high crystallinity is small, the force of adhering to resin is small. If the agglomerate size is large, the interface area between resin and carbon fiber is large, which leads to separation and crack at the interface. If the average size of agglomerate exceeds 10 μm, the mechanical strength decreases by half based on the strength of the resin alone, and that is not preferred.

In the arbitrary cross-section of the resin composition, the area ratio of carbon fiber agglomerates is 5% or less, preferably 3% or less, more preferably 1% or less.

The area ratio of carbon fiber agglomerate, in other words, existence ratio or share of the agglomerates is related to interface separation and crack, similarly with the size of agglomerates. With respect to the blending ratio of the carbon fiber in the present invention, if the area ratio exceeds 5%, an electroconductive path is hard to form, resulting in unsatisfactory electroconductivity and mechanical strength of the resin composition.

Accordingly, in order to obtain electroconductivity without deteriorating the mechanical strength, it is necessary to reduce the agglomerate size and the agglomerate share in the resin composition.

### EXAMPLES

Hereinafter, the present invention is explained more specifically by referring to representative examples. However, the examples shown below are mere illustrations and the present invention is by no means limited thereto.

The method for determining the shape parameters of the carbon fiber is described below. The average size was calculated by taking SEM (scanning electron microscope) images of 30 fields of view at a magnification of ×30,000 and measuring the diameters of 300 filaments by an image analyzer (LUZEX-AP, manufactured by NIRECO Corporation). The average filament length was calculated by taking SEM (scanning electron microscope) images of 30 fields of view continuously and panoramically at a magnification of ×3000 and measuring the lengths of 300 filaments by an image analyzer. The aspect ratio was calculated by dividing the average filament length by the average filament diameter. The branching degree of the carbon fiber was calculated as number of branching portions per one filament by dividing the total number of branching portions observed in the above-described analysis of the filament length by the filament number 300.

The method for measuring various properties of carbon fiber is described below.

The BET specific surface area was measured by nitrogen gas adsorption method (NOVA1000, manufactured by Yuasa Ionics, Inc.).

The average interplaner spacing d₀₀₂ was measured by an X-Ray Powder diffractometer (Geigerflex, manufactured by Rigaku Corporation) with the inner standard of Si. The peak height ratio (Id/Ig) wherein Id is a peak height of a band ranging from 1,341 to 1,349 cm⁻¹ and Ig is a peak height of a band ranging from 1,570 to 1,578 cm⁻¹ in the Raman scattering spectrum was measured by a Raman spectrophotometer(LabRam HR, manufactured by Jobin Yvon).

The method for analyzing agglomerates in the resin composite is described below.

Preparation of the analysis samples: The analysis samples were prepared by cutting a formed product into flakes having a thickness of 0.8 to 1.0 μm with a microtome for optical microscope. Ten flakes were thus cut out at 20 μm intervals in the thickness direction from the formed product.
Observation of the samples: The flakes were filled with liquid paraffin to serve as analysis samples. The samples were observed by taking TEM (transmission electron microscope) bright-field images at a magnification of ×1000. The pictures were binarized by an image analyzer LUZEX-AP, manufactured by NIRECO Corporation and the agglomerate diameter corresponding to a circle and the total agglomerate area were determined.

The volume ratio of carbon fiber agglomerate to single carbon fiber filament constituting the agglomerate can be determined by the ratio of the average agglomerate volume of an assumed sphere calculated from the agglomerate diameter corresponding to a circle to the average carbon fiber filament volume of an assumed cylindrical column calculated from the average filament diameter and length.

The area ratio is the ratio of the total agglomerate area to the total observation and measurement area of the 10 fields of view.

Volume resistance values less than 10⁸ Ωcm of the resin composite were measured by four-probe method (Loresta HP MCP-T410, manufactured by Mitsubishi Chemical Corporation), and values of 10⁸ Ωcm or more were measured by an insulating-resistance tester (R8340, a high resistance meter manufactured by Advantest Corporation).

Izod impact resistance was measured by using an Izod impact tester (manufactured by Toyo Seiki Kogyo, Co., Ltd.)in accordance with JIS K-7110. The shape of sample piece used was 64 mm (length), 12.7 mm (thickness) and 3.2 mm (width). With respect to the notch size, the tip radius was 0.25 mm and the notch depth was 2.54 mm.

### Production of Carbon Fiber 1:

Benzene, ferrocene and sulfur (proportion by mass: 96:3:1) were mixed together, to thereby prepare a liquid raw material. The liquid raw material was sprayed at spraying angle of 75° by use of hydrogen serving as a carrier gas into a reaction furnace made of SiC (inner diameter: 120 mmφ, height: 2,000 mm) which had been heated to 1,250° C. The supply rate of the raw material was 12 g/min and the flow rate of the hydrogen was 60 L/min.

The product (100 g) obtained through the above process was charged into a graphite-made crucible (inner diameter: 100 mmφ, height: 150 mm), and baked in an argon atmosphere at 1,000° C. for one hour. Thereafter, the resultant product was graphitized in an argon atmosphere at 2,800° C. for one hour.

### Production of Carbon Fiber 2:

Benzene, ferrocene and thiophene (proportion by mass: 92:7:1) were mixed together, to thereby prepare a liquid raw material. The liquid raw material was supplied to a vaporizer which had been set to 300° C., to thereby vaporize the liquid raw material. The vaporized raw material was supplied by use of hydrogen serving as a carrier gas into a reaction furnace made of SiC (inner diameter: 120 mmφ, height: 2,000 mm) which had been heated to 1,200° C. The supply rate of the raw material was 10 g/min and the flow rate of the hydrogen was 60 L/min.

The product (80 g) obtained through the above process was charged into a graphite-made crucible (inner diameter: 100 mmφ, height: 150 mm), and baked in an argon atmosphere at 1,000° C. for one hour. Thereafter, the resultant product was graphitized in an argon atmosphere at 2,800° C. for 30 minutes.

### Production of Carbon Fiber 3:

98 g of the carbon fiber obtained by the same reaction and firing treatment as in production of carbon fiber 1 and 2 g of B₄C were mixed with a Henschel mixer. 100 g of the mixture was charged into a graphite-made crucible (inner diameter: 100 mmφ, height: 150 mm), and graphitized in an argon atmosphere at 2,800° C. for 30 minutes.

### Production of Carbon Fiber 4:

Benzene, ferrocene and thiophene (proportion by mass: 92:7:1) were mixed together, to thereby prepare a liquid raw material. The liquid raw material was supplied to a vaporizer which had been set to 300° C., to thereby vaporize the liquid raw material. The vaporized raw material gas was supplied by use of hydrogen serving as a carrier gas into a reaction furnace made of SiC (inner diameter: 120 mmφ, height: 2,000 mm) which had been heated to 1,200° C. The supply rate of the raw material was 8 g/min and the flow rate of the hydrogen was 80 L/min.

The product (80 g) obtained through the above process was charged into a graphite-made crucible (inner diameter: 100 mmΦ, height: 150 mm), and baked in an argon atmosphere at 1,000° C. for one hour. Thereafter, the resultant product was graphitized in an argon atmosphere at 2,800° C. for 30 minutes.

### Production of Carbon Fiber 5:

Benzene, ferrocene and sulfur (proportion by mass: 96:3:1) were mixed together, to thereby prepare a liquid raw material. The liquid raw material was sprayed at spraying angle of 80° by use of hydrogen serving as a carrier gas into a reaction furnace made of SiC (inner diameter: 120 mmΦ, height: 2,000 mm) which had been heated to 1,250° C. The supply rate of the raw material was 70 g/min and the flow rate of the hydrogen was 60 L/min.

The product (80 g) obtained through the above process was charged into a graphite-made crucible (inner diameter: 100 mmΦ, height: 150 mm), and baked in an argon atmosphere at 1,000° C. for one hour. Thereafter, the resultant product was graphitized in an argon atmosphere at 2,800° C. for 30 minutes.

### Production of Carbon Fiber:

A mixture of ethylene gas and hydrogen gas and alumina supporting iron having a diameter of about 2 nm were supplied into a quartz-made reaction tube (inner diameter: 60 mmΦ, height: 1,000 mm) which had been heated to 800° C. The flow rates of the ethylene and the hydrogen were 2 L/min and 1 L/min, respectively.

### Example 1

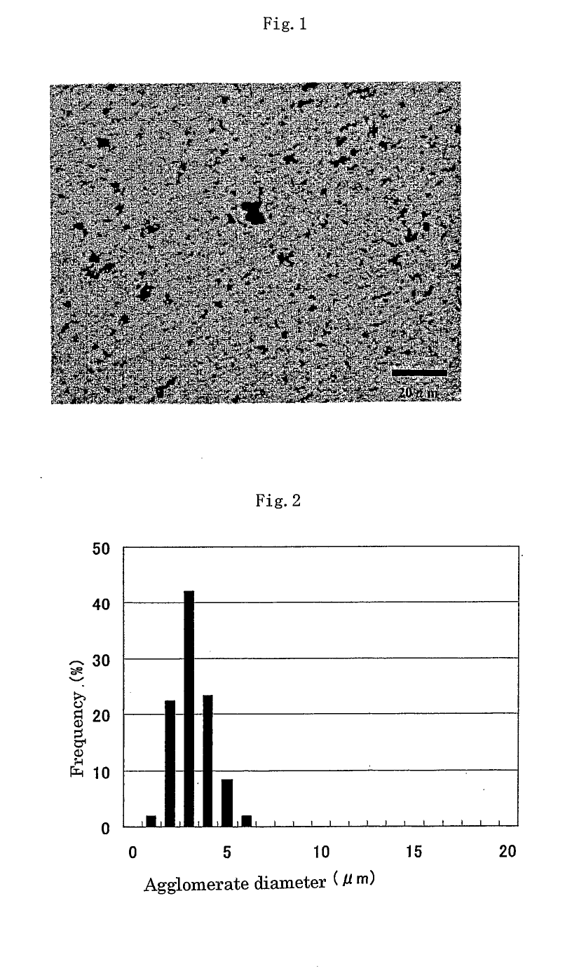

90 mass % of polycarbonate resin (Iupilon H4000 manufactured by Mitsubishi Gas Chemical Company, Inc.) and 10 mass % of carbon fiber 1 were molten-kneaded at 240° C. and 80 rpm by using a Labo-Plastmill (manufactured by Toyo Seiki Co., Ltd.) for 10 minutes (mixing energy: 850 MJ/m³) and then molded into a plate of 10 mm×10 mm×2 mmt by using a 50 t thermoforming device (manufactured by Nippo Engineering Co. Ltd.) under the condition of the temperature of 250° C., the pressure of 200 kgf/cm² and the time of 30 seconds, to thereby obtain composite 1. The optical micrograph of a cross section of the plate is shown in FIG. 1 and the analysis result of the aggregate diameter in the micrograph is shown in FIG. 2.

### Example 2

Polycarbonate resin (Iupilon H4000 manufactured by Mitsubishi Gas Chemical Company, Inc.) and carbon fiber 2 were kneaded (mixing energy: 950 MJ/m³) in the same manner as in Example 1 and then molded to thereby obtain composite 2.

### Example 3

Polycarbonate resin (Iupilon H4000 manufactured by Mitsubishi Gas Chemical Company, Inc.) and carbon fiber 3 were kneaded (mixing energy: 820 MJ/m³) in the same manner as in Example 1 and then molded to thereby obtain composite 3.

### Example 4

Polycarbonate resin (Iupilon H4000 manufactured by Mitsubishi Gas Chemical Company, Inc.) and carbon fiber 4 were kneaded (mixing energy: 980 MJ/m³) in the same manner as in Example 1 and then molded to thereby obtain composite 4.

### Comparative Example 1

Polycarbonate resin (Iupilon H4000 manufactured by Mitsubishi Gas Chemical Company, Inc.) and carbon fiber 5 were kneaded (mixing energy: 800 MJ/m³) in the same manner as in Example 1 and then molded to thereby obtain composite 5.

### Comparative Example 2

Polycarbonate resin (Iupilon H4000 manufactured by Mitsubishi Gas Chemical Company, Inc.) and carbon fiber 6 were kneaded (mixing energy: 1120 MJ/m³) in the same manner as in Example 1 and then molded to thereby obtain composite 6.

The physical properties of the carbon fibers 1 to 6 are shown in Table 1.

TABLE 1

| | | | | | Comparative | comparative |
|---|---|---|---|---|---|---|
| | Example 1 | Example 2 | Example 3 | Example 4 | Example 1 | Example 2 |
| | carbon | carbon | carbon | carbon | carbon | carbon |
| | fiber 1 | fiber 2 | fiber 3 | fiber 4 | fiber 5 | fiber 6 |
| fiber | 200 | 90 | 200 | 60 | 300 | 20 |
| diameter | | | | | | |
| (nm) | | | | | | |
| fiber length | 12 | 20 | 12 | 12 | 9 | 3 |
| (μm) | | | | | | |
| aspect ratio | 60 | 222 | 60 | 200 | 30 | 150 |
| (—) | | | | | | |
| branch degree | 1 | 4 | 1 | 1 | 25 | 0 |
| (branch number/ | | | | | | |
| one filament) | | | | | | |
| specific | 10 | 22 | 10 | 38 | 7 | 100 |
| surface area | | | | | | |
| (m²/g) | | | | | | |
| d₀₀₂(nm) | 0.340 | 0.342 | 0.338 | 0.343 | 0.340 | 0.348 |
| Id/Ig(—) | 0.2 | 0.1 | 1.0 | 0.1 | 0.3 | 0.5 |

The physical properties of composites 1 to 6 obtained in Examples 1 to 4 and comparative examples 1 and 2 are shown in Table 2.

TABLE 2

| | Example No. | | | | | |
|---|---|---|---|---|---|---|
| | | | | | Comparative | Comparative |
| | 1 | 2 | 3 | 4 | Example 1 | Example 2 |
| Composite | 1 | 2 | 3 | 4 | 5 | 6 |
| No. | | | | | | |
| mixing | 850 | 950 | 820 | 980 | 800 | 1120 |
| energy | | | | | | |
| (MJ/m³) | | | | | | |
| average | 3.2 | 6.3 | 2.4 | 4.3 | 10.9 | 3.8 |
| agglomerate | | | | | | |
| diameter | | | | | | |
| (μm) | | | | | | |
| volume | 35 | 330 | 20 | 1230 | 50000 | 16000 |
| ratio | | | | | | |
| of | | | | | | |
| agglomerate | | | | | | |
| to one | | | | | | |
| carbon | | | | | | |
| fiber | | | | | | |
| area | 0.9 | 1.5 | 1.0 | 2.3 | 8.5 | 7.3 |
| ratio(%) | | | | | | |
| volume | 1.2 × 10⁸ | 3.5 × 10² | 6.8 × 10⁵ | 2.2 × 10¹ | 3.5 × 10¹⁵ | 4.4 × 10² |
| resistance | | | | | | |
| (Ωcm) | | | | | | |
| composite/ | 1.05 | 0.95 | 1.00 | 0.90 | 0.65 | 0.40 |
| material | | | | | | |
| resin | | | | | | |
| (Izod notch | | | | | | |
| impact | | | | | | |
| resistance | | | | | | |
| ratio) | | | | | | |

### INDUSTRIAL APPLICABILITY

In the electroconductive resin composition of the present invention, carbon fiber is uniformly dispersed without forming agglomerates and therefore with addition of a small amount of carbon fiber, excellent electroconductivity can be achieved without deterioration of the mechanical properties.

Further, the electroconductive resin composition of the present invention can be widely used as various secondary batteries such as dry battery, Pb accumulator battery, capacitor or recent lithium ion secondary battery; transparent electrode; electromagnetic shielding; antistatic material; electrically conductive coating material; electrically conductive adhesive or the like.

1. An electroconductive resin composition comprising 1 to 30 mass % of carbon fiber having a hollow structure, an average filament diameter of 50 to 500 nm and an average aspect ratio of 50 to 1000 and 99 to 70 mass % of resin, wherein the volume ratio of carbon fiber agglomerate to one carbon fiber filament constituting the agglomerate in the resin composition (volume of carbon fiber agglomerate/volume of a carbon fiber filament) is 1500 or less.

2. The electroconductive resin composition according to claim 1, wherein the BET specific surface area of the carbon fiber is from 3 to 50 m²/g, the average interplaner spacing d₀₀₂ is 0.345 nm or less and in the Raman scattering spectrum, the peak height ratio (Id/Ig) of a band ranging from 1341 to 1349 cm⁻¹ (Id) to a band ranging from 1570 to 1578 cm⁻¹ is from 0.1 to 1.4.

3. The electroconductive resin composition according to claim 1, wherein each filament of the carbon fiber has 5 or less portions branching from the filament surface.

4. The electroconductive resin composition according to claim 1, wherein the resin is a thermoplastic resin, a thermosetting resin or a photocurable resin.

5. The electroconductive resin composition according to claim 1, wherein the average diameter of carbon fiber agglomerates in the resin composition is 0.2 to 10 μm.

6. The electroconductive resin composition according to claim 1, wherein the area ratio of carbon fiber agglomerate in an arbitrary cross-section of the resin composition is 5% or less.

7. The electroconductive resin composition according to claim 1, wherein the volume resistivity value is 10¹⁰ Ωcm or less.

8. The electroconductive resin composition according to claim 7, wherein the ratio of Izod Notch impact resistance values of the resin composition to resin raw material (the electroconductive resin composition/resin raw material) is 0.9 or more.

9. A method for producing an electroconductive resin composition, wherein 1 to 30 mass % of carbon fiber having a hollow structure, an average filament diameter of 50 to 500 nm and an average aspect ratio of 50 to 1000 is mixed with 99 to 70 mass % of molten thermoplastic resin and the mixing energy is 1000 MJ/m³ or less.

10. A method for producing an electroconductive resin composition, wherein 1 to 30 mass % of carbon fiber having a hollow structure, an average filament diameter of 50 to 500 nm and an average aspect ratio of 50 to 1000 is mixed with 99 to 70 mass % of liquid thermosetting resin and the mixing energy is 1000 MJ/m³ or less.

11. A method for producing an electroconductive resin composition, wherein 1 to 30 mass % of carbon fiber having a hollow structure, an average filament diameter of 50 to 500 nm and an average aspect ratio of 50 to 1000 is mixed with 99 to 70 mass % of liquid photocurable resin precursor, and the mixing energy is 1000 MJ/m³ or less.

12. A method for producing an electroconductive resin composition, wherein 99 to 70 mass % of thermoplastic resin pellets are supplied from a hopper of a kneader and 1 to 30 mass % of carbon fiber having a hollow structure, an average filament diameter of 50 to 500 nm and an average aspect ratio of 50 to 1000 is side-fed.

13. A method for producing an electroconductive resin composition, wherein 99 to 70 mass % of thermoplastic resin powder is supplied mixed with 1 to 30 mass % of carbon fiber having a hollow structure, an average filament diameter of 50 to 500 nm and an average aspect ratio of 50 to 1000 and then the mixture is subjected to molten kneading.

14. A method for producing an electroconductive resin composition, wherein 99 to 70 mass % of thermosetting resin is mixed with 1 to 30 mass % of carbon fiber having a hollow structure, an average filament diameter of 50 to 500 nm and an average aspect ratio of 50 to 1000 and then the mixture is subjected to curing with heat.

15. An antistatic material using the electroconductive resin composition described in claim 1.

16. An electroconductive coating material using the electroconductive resin composition described in claim 1.

17. An electroconductive adhesive using the electroconductive resin composition described in claim 1.
